(19) United States
(12) Patent Application Publication
(10) Pub. No.: US 2002/0079411 A1
(43) Pub. Date: Jun. 27, 2002

(54) Posturecubes

(76) Inventor: Andrei Pricope, Aurora, IL (US)

Correspondence Address: Charles F. Meroni, Jr., Meroni & Meroni, P.C., P.O. Box 309, Barrington, IL, 60011, US

(21) Appl. No.: 09/748,360

(22) Filed: Dec. 27, 2000

(51) Int. Cl. F16M 11/24

(52) U.S. Cl. 248/188.2; 248/188.9; 248/346.11

(57) ABSTRACT

The present invention concerns a device for promoting posture and for providing support and a combination of the device and a sitting structure, such as a chair. The device comprises a multi-level riser of unibody construction that includes a first surface, a second surface opposite the first surface, and a plurality of perimeter sides. The first surface has a first hole that is defined therein and the second surface has a second hole that is defined therein. At least one raised surface is positioned inside each of the first hole and the second hole and each raised surface can have a different depth measurement with respect to one another.

### BACKGROUND OF THE INVENTION

1. Field of the Invention

The present invention relates to devices for promoting posture and for providing back support to a user. More specifically, the present invention is primarily intended as a device for correcting position of the lumbar area of a user's back while sitting or reclining upon a sitting structure, such as a chair, for use in the performing arts, the workplace, and the like.

2. Description of the Related Art

Sitting structures and devices, such as chairs, benches, stools, boxes, crates, etc. are used every day in today's society and have been used for centuries past for supporting people during various activities. In the work place and in the performing and entertaining arts sitting structures are used for supporting people who are required to work or perform at high levels of production and efficiency. As is often the case, over the course of the work day or performance, the worker's or performer's body tires and weakens. As the body weakens, the posture of the body is not maintained properly, and productivity, efficiency, and alertness decrease. When proper posture is maintained, not only is productivity maintained, but it can be increased. In the performing arts, for example, this translates into heightened awareness and a greater ability to project musical and vocal sound and quality. In other words, the entire performance can be significantly improved by promoting, increasing, and assisting proper posture and by providing support to the body and back.

Although devices, such as belts, pillows, and ergonomically designed chairs, have been developed, there is a need for simple devices or apparatuses that can be applied to the vast majority of existing sitting structures and that require no modification to existing chairs, stools, tables, and the like. Therefore it is important and necessary that a device be developed for promoting posture and for providing back support to the user of the device. In particular, it is important and necessary to supplement the various existing sitting structures and devices used in work place, performing arts, etc. so that workers and performers alike can improve their productivity and output. It is also desirable that the device be inexpensive, simple to manufacture, easy to use, and applicable to various types of sitting structures, and the like.

Other objects of my invention, as well as particular features, elements, and advantages thereof, will be elucidated in, or apparent from, the following description and the accompanying drawing figures.

### SUMMARY OF THE INVENTION

The present invention provides a device for promoting posture and for providing back support to the user of the device. The present invention may be used with a sitting structure, such as a table, chair, bench, etc. The device comprises a multi-level riser of unibody construction that includes a first surface, a second surface opposite the first surface, and a plurality of perimeter sides. The first surface has a first hole defined therein and the second surface has a second hole defined therein. At least one raised surface may be positioned inside each of the first hole and the second hole.

Each raised surface may then be positioned at a different depth within its respective hole for providing different riser levels for the table, chair, bench, etc. that is placed on the corresponding raised surface. Once raised, the table, chair, bench, etc. is sloped forward for promoting proper posture and for providing back support for one using the table, chair, bench, etc. while one is performing an act, such as playing a musical instrument.

Another embodiment of the present invention provides in combination, a device for promoting posture and for providing support that comprises at least two multi-level risers and a sitting structure. Each multi-level riser may be constructed of unibody construction including a first surface, a second surface opposite the first surface, and a plurality of perimeter sides positioned thereabout. The first surface can have a first hole defined therein and the second surface can have a second hole defined therein. A first raised surface may be located within the first hole at a first hole depth as measured from the first surface and a second raised surface may be located within the second hole at a second hole depth measured from the second surface. The second hole depth can differ from the first hole depth. The sitting structure can include at least two sitting supports for positioning on the at least two multi-level risers for promoting posture and for providing support during usage.

Finally, in another embodiment of the present invention, a posture positioning and support providing apparatus comprises a device including a plurality of perimeter walls that extend along an axial direction and that define a plurality of supporting surfaces that are orthogonally positioned between the plurality of perimeter walls. The plurality of perimeter walls include opposing axially directed end surfaces. The plurality of supporting surfaces can be positioned in back-to-back relationship to one another and can also be positioned between the opposing axially directed end surfaces.

Hence, the present invention provides a device developed for promoting posture and for providing back support to the user of the device. In particular, the device of the present invention supplements the various existing sitting structures and devices used in the work place, performing arts, etc. so that workers and performers alike can improve their productivity and output. The device of the present invention is also inexpensive, simple to manufacture, easy to use, and is applicable to various types of sitting structures, and the like.

### DESCRIPTION OF THE DRAWINGS

Other features of my invention will become more evident from a consideration of the following detailed description of my patent drawings, as follows:

FIG. 1 is a perspective view of an embodiment of the present invention showing a first surface, a first hole, and a first raised surface therein;

FIG. 2 is a perspective view of the embodiment of FIG. 1 of the present invention showing a second surface, a second hole, and a second raised surface therein;

FIG. 3 is a cross sectional view of the embodiment of FIG. 1 showing the first hole and the second hole and the relationship therebetween;

FIG. 4 is a side view of a sitting device and a user without usage of the device of the present invention; and

FIG. 5 is a side view of the sitting device wherein the user uses the device of the present invention for promoting proper posture and for providing back support.

### DETAILED DESCRIPTION OF THE PREFERRED EMBODIMENT

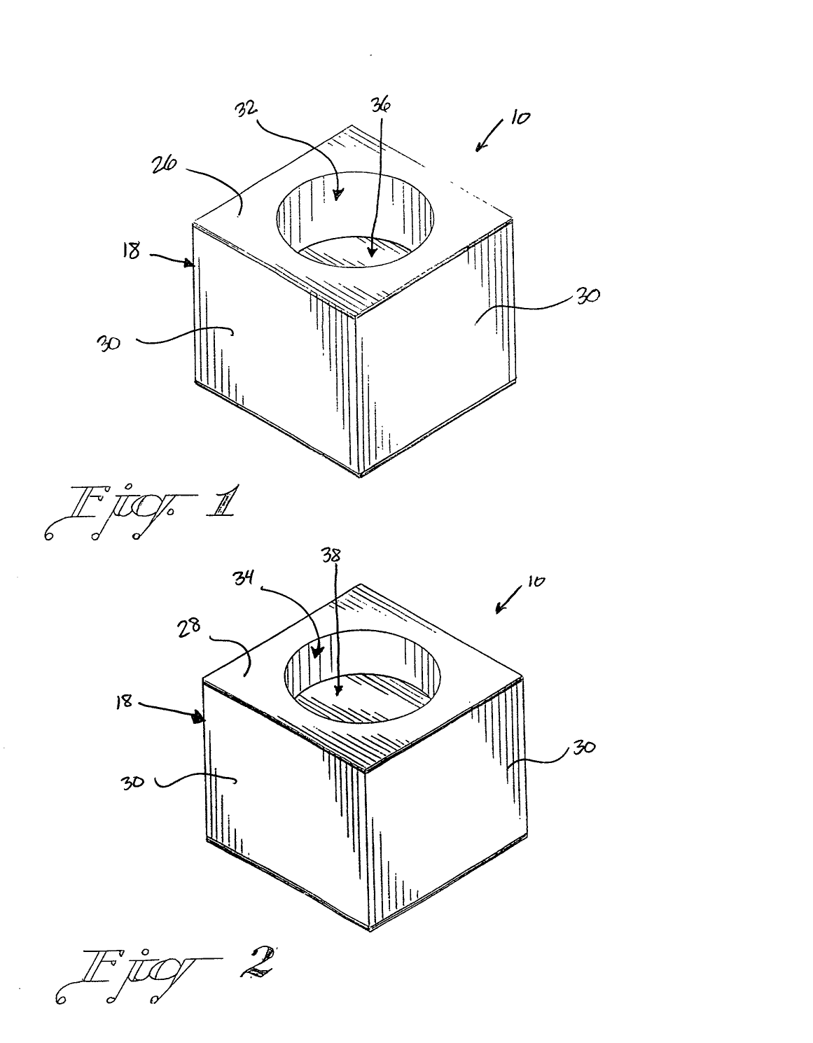

Referring now to the drawings, the present invention concerns a device or apparatus for promoting posture and for providing back and bodily support to a user of the device, as illustrated by way of example in FIGS. 1-5. It is not intended that the present invention be limited solely to posture promoting and support providing apparatuses for usage with workplace and performing arts applications, rather the scope of the invention includes other applications, etc. where sitting and the like are involved. For example, the device could be used with eating activities.

As is illustrated in FIGS. 1-3 and 5, the present invention includes a device or apparatus 10, for promoting improved or proper posture and for providing back and bodily support to a user 12 of the device. In addition, the device 10 is particularly applicable for usage with existing sitting structures and sitting devices 14 (see FIG. 5), such as chairs, boxes, tables, crates, stools, benches and the like wherein the user 12 has need to sit for any reason. It is not necessary that the sitting structure be altered or modified to work with the device 10. Moreover, as is shown in FIG. 5, the device 10 of the present invention has particular application with the performing or musical arts 16, although the device can be used in the workplace, at home, and for other sitting needs.

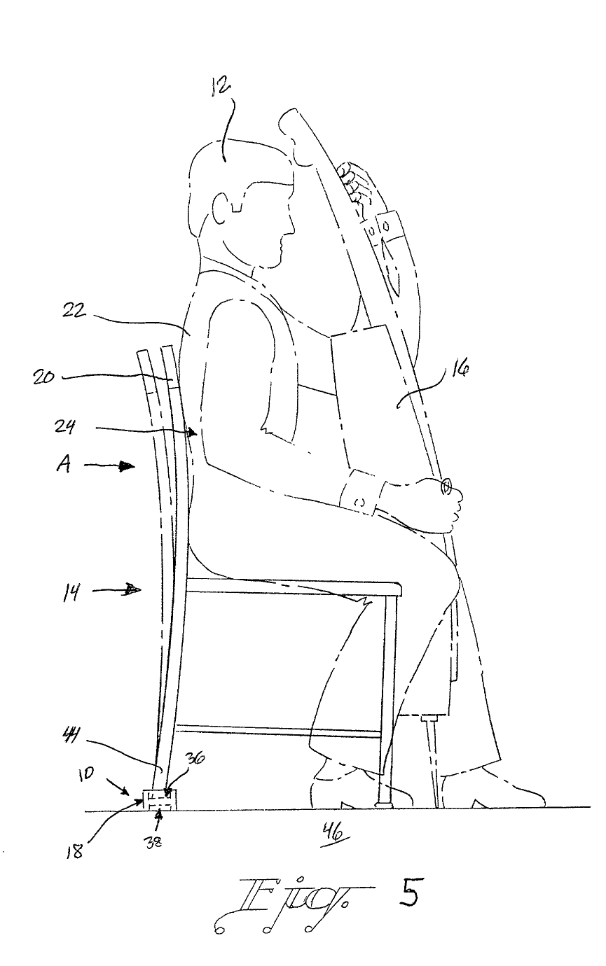

As is shown in FIGS. 1-3 and 5, the device 10 of the present invention comprises a multi-level riser 18 that can be constructed of one or more materials, such as wood, plastic or synthetics, metal and so forth, and that can be constructed of a single material throughout its structure or with a hybrid of the materials contained therein. Construction can be made using available technologies, such as drilling, injection molding, fabrication, and so forth. The various elevations generated by the device 10 as described below can also be specified according to the needs of the user 12 and can be manufactured accordingly. In other words, the device 10 can be made to any size and depth needed. As will be described below and as shown in FIG. 5, the multi-level riser 18 is both multi-level and a riser because of its structure and ability to raise the sitting structure 14 to different levels or elevations, thereby tilting or sloping the sitting user 12 upwards and forwards. The device 10 also provides back and bodily support in conjunction with the sitting structure 14 by lifting a back support 20 of the sitting structure upwards and towards a user's 12 back 22 as shown in FIG. 5. The device 10 of the present invention finds particular benefit in supporting a lumbar portion 24 of the back 22 and in correcting the posture of the lumbar portion. This is done by pushing the lumbar portion 24 forwards (arrow A in FIG. 5) for straightening and supporting the back as is shown by comparing the position of the back 22 of the user 12 in FIGS. 4 and 5 and as shown by the rotation and elevation of the sitting structure 14 shown in phantom in FIG. 5.

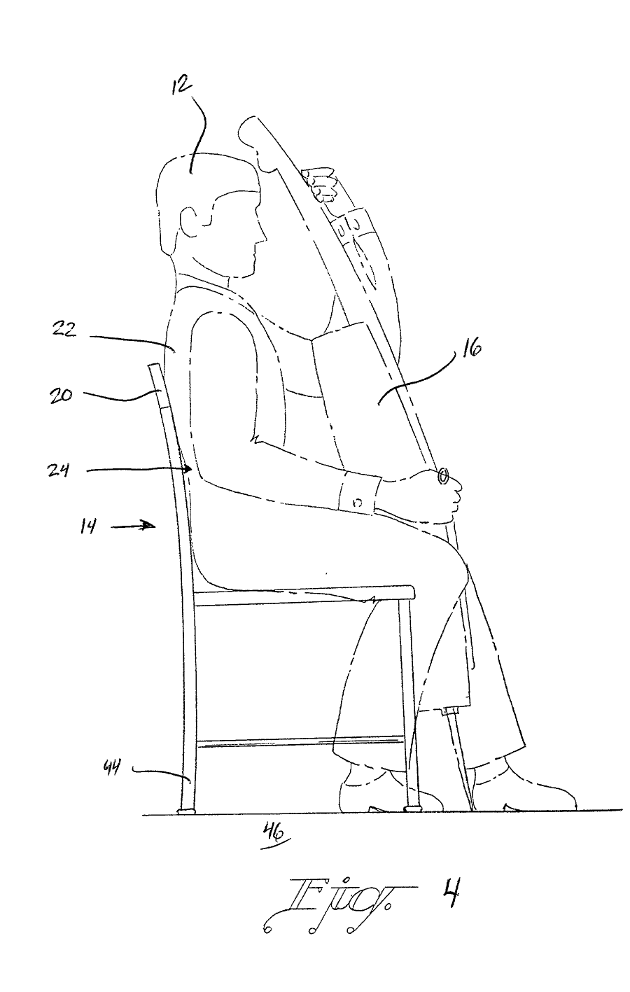

Now, as is illustrated in FIGS. 1-3, the multi-level riser 18 of the device 10 further comprises a first surface 26, a second surface 28 positioned opposite the first surface, and a plurality of perimeter sides or walls 30. The first surface and the second surface, hence provide opposing axially directed end surfaces. The first surface has a first hole 32 defined therein while the second surface has a second hole 34 defined therein. Both holes 32, 34 represent important features of the present invention. A first raised surface 36 is provided within the first hole 32 while a second raised surface 38 is provided within the second hole 34 and is positioned opposite the first raised surface. In a preferred embodiment, the first raised surface 36 and the second raised surface 38 are positioned in back-to-back relationship to one another as is shown in FIGS. 3 and 5. Moreover, in a preferred embodiment, the first raised surface and the second raised surface are orthogonally or perpendicularly positioned relative to the plurality of perimeter sides 30 for providing a level surface for support, stability, and ease of usage.

As is shown in FIG. 3, the first hole 32, the second hole 34, the first raised surface 36, and the second raised surface 38 can be concentrically and/or axially aligned and directed with one another along an axial axis 39 for maximum stability and utility. Importantly, the first raised surface 36 is located within the first hole 32 at a first hole depth as measured from the first raised surface to the first surface 26. In like manner, the second raised surface 38 is located within the second hole 34 at a second hole depth 42 as measured from the second raised surface to the second surface 28. In the preferred embodiment, the first hole depth 40 and the second hole depth 42 can have different values from one another for providing the multi-level aspect of the multi-level riser 18, and in essence, provide adjustability to the amount of slope or tilt applied to the sitting structure 14 and provide variability in the degree of subsequent correction and support provided to the back 22. The depths 40, 42 can also be substantially similar depth values if needed.

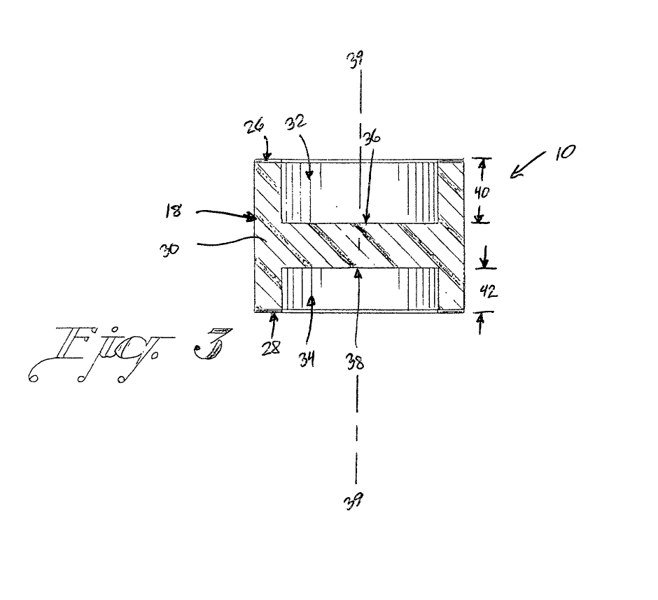

Also in a preferred embodiment, the device 10 can have a cube shape, as illustrated by way of example in FIGS. 1-3 and 5 for maximizing stability and for simplifying manufacturing. Other shapes, such as rectangular and polygonal shapes are also contemplated as within the scope of the present invention. The first hole 32 and the second hole 34 are preferably sized and shaped for receiving a leg or sitting support 44 of the sitting structure 14. The shape of the first hole and the second hole can be circular in diameter and cylindrical in volume as is illustrated in FIGS. 1 and 2. In addition, the shapes and diameters of the first and second holes 32, 34 can be equal or unequal in measurement as needed. Other shapes, such as square and polygonal shapes and so forth, can also be provided for the areas of the first and second raised surfaces 36, 38 and can include corresponding shaped volumes. In addition, friction surfaces may be provided on the first and second surfaces 26, 28 as needed for providing resistance to sliding forces while the device 10 is being used.

Finally, in application and operation, as is illustrated in FIG. 5, the device 10 of the present invention can be used singly, but is preferably used in pairs for elevating the rear legs 44 of the sitting structure 14 to one or more elevations depending upon which of the first or second holes 32, 34 is placed towards and on a floor surface 46 and which hole receives the legs 44. Once placed on the floor surface and once the legs 44 are placed within the first hole 32 or the second hole 34 of the risers 18, then the user 12 sits on the sitting structure 14 and rests his/her back 22 on the raised and repositioned back support 20 for positioning the lumbar portion 24 forward in proper posture for the subsequent action undertaken by the user. For example, as illustrated in FIG. 5, the user 12 can then sit more uprightly and closer to a musical instrument of the musical arts 16 and can also find support in maintaining the proper posture throughout his/her performance while using the sitting structure 14. In essence, the device 10 of the present invention allows the user 12 to lean back on the sitting structure 14 and still maintain proper posture, even when fatigue sets in.

In construction and in usage the present invention therefore provides a device developed for promoting posture and for providing back support to the user of the device. In particular, the device of the present invention supplements the various existing sitting structures and devices used in the work place, performing arts, etc. so that workers and performers alike can improve their productivity and output. The device of the present invention is also inexpensive, simple to manufacture, easy to use, and is applicable to various types of sitting structures, and the like.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

What is claimed is:

1. A device for promoting posture and for providing back support comprising: a multi-level riser of unibody construction including a first surface, a second surface opposite the first surface, and a plurality of perimeter sides, the first surface having a first hole defined therein and the second surface having a second hole defined therein, and at least one raised surface positioned inside each of the first hole and the second hole.

2. The device of claim 1, wherein the first hole and the second hole have different depth measurements measured from the first surface and the second surface respectively.

3. The device of claim 2, wherein the first hole and the second hole are concentrically aligned and positioned in back-to-back relationship relative to one another.

4. The device of claim 1, wherein the first surface, the second surface, and the plurality of perimeter sides form a cube-shaped multi-level riser, the first hole and the second hole having circular diameters.

5. The device of claim 4, wherein the first hole and the second hole are sized for receiving and for elevating chair legs from a floor surface for promoting posture and for providing back support.

6. In combination, a device for promoting posture and for providing support comprising:
at least two multi-level risers, each multi-level riser being constructed of unibody construction including a first surface, a second surface opposite the first surface, and a plurality of perimeter sides thereabout, the first surface having a first hole defined therein and the second surface having a second hole defined therein, a first raised surface located within the first hole at a first hole depth from the first surface and a second raised surface located within the second hole at a second hole depth from the second surface, the second hole depth differing from the first hole depth; and
a sitting structure including at least two sitting supports for positioning on the at least two multi-level risers for promoting posture and for providing support during usage.

7. The combination of claim 6, wherein the sitting structure is selected from the group consisting of chairs, tables, boxes, crates, stools, and benches.

8. The combination of claim 6, wherein the at least two sitting supports are positioned on the first raised surface within the first hole of each of the multi-level risers.

9. The combination of claim 6, wherein the at least two sitting supports are positioned on the second raised surface within the second hole of each of the multi-level risers.

10. The combination of claim 6, wherein each multi-level riser is constructed of a material selected from the group consisting of wood, synthetics, and metal.

11. The combination of claim 10, wherein the material includes a hybrid construction.

12. The combination of claim 6, wherein each multi-level riser has a cube shape and the first hole and the second hole have cylindrical shapes.

13. A posture positioning and support providing apparatus comprising:
a device including a plurality of perimeter walls extending along an axial direction and defining a plurality of supporting surfaces orthogonally positioned between the plurality of perimeter walls, the plurality of perimeter walls including opposing axially directed end surfaces, the plurality of supporting surfaces being positioned in back-to-back relationship to one another and positioned between the opposing axially directed end surfaces.

14. The apparatus of claim 13, wherein each of the supporting surfaces is positioned between the opposing axially directed end surfaces at different axial positions.

15. The apparatus of claim 14, wherein the different axial positions define different depth measurements from the respective opposing axially directed end surfaces.

16. The apparatus of claim 13, wherein the plurality of supporting surfaces have shapes selected from the group consisting of circular, square, and polygonal.

17. The apparatus of claim 13, wherein the plurality of supporting surfaces have diameter measurements that are substantially equal in value to one another.

18. The apparatus of claim 13, wherein the plurality of supporting surfaces have diameter measurements that are substantially unequal in value to one another.

19. The apparatus of claim 13, wherein the plurality of supporting surfaces are concentrically aligned with one another along the axial direction.
